(19) United States
(12) Patent Application Publication
(10) Pub. No.: US 2017/0227816 A1
(43) Pub. Date: Aug. 10, 2017

(54) LED BACKLIGHT UNIT WITH SEPARATELY AND INDEPENDENTLY DIMMABLE ZONES FOR A LIQUID CRYSTAL DISPLAY

(71) Applicant: GLO AB, Lund (SE)

(72) Inventors: Michael JANSEN, Palo Alto, CA (US); Sheng-Min WANG, Taipei (TW); Fariba DANESH, Pleasanton, CA (US)

(21) Appl. No.: 15/429,338

(22) Filed: Feb. 10, 2017

Related U.S. Application Data
(60) Provisional application No. 62/293,484, filed on Feb. 10, 2016.
(60) Provisional application No. 62/320,743, filed on Apr. 11, 2016.

(51) Int. Cl. G02F 1/1335; H05B 33/08

(52) U.S. Cl. CPC G02F 1/133603; H05B 33/0857; G02F 1/133605; G02F 1/133606; G02F 2001/133612

(57) ABSTRACT

A liquid crystal display module includes a plurality of liquid crystal pixels and a backlight unit containing white-light-emitting LEDs located in individually dimmable zones. Selectively brightening or dimming one or more individually dimmable zones to directly illuminate one or more pixels with brighter or dimmer white light.

### RELATED APPLICATIONS

The present application claims benefit of priority of U.S. Provisional Application Ser. No. 62/293,484 filed on Feb. 10, 2016 and U.S. Provisional Application Ser. No. 62/320,743 filed on Apr. 11, 2016, the entire disclosures of which are incorporated herein by reference.

### FIELD

The embodiments of the invention are directed generally to methods of transferring devices, such as semiconductor light emitting devices to a target substrate. The methods of the present disclosure may be employed to form a direct view light emitting device display panel employing a light emitting device array on a backplane.

### BACKGROUND

A device array including semiconductor devices such as light emitting diodes can be employed for various applications. For example, light emitting devices such as light emitting diodes are used in electronic displays, such as liquid crystal displays in laptops or LED television sets. Light emitting devices include light emitting diodes (LEDs) and various other types of electronic devices configured to emit light. Reliable methods are desired for systematically transferring a selected set of devices from a supply coupon to a target substrate.

### SUMMARY

According to an aspect of the present disclosure, a display unit comprising a backlight illumination unit is provided. The backlight illumination unit comprises: a backplane substrate; a plurality of white-light-emitting light emitting diodes (LEDs) attached to the backplane substrate and arranged in a plurality of individually dimmable zones; and electrodes located on the backplane substrate and individually connected to each of the plurality of white-light-emitting LEDs. The plurality of white-light-emitting LEDs are configured to be individually controllable to provide brighter or dimmer white light from each selected individually dimmable zone among the plurality of individually dimmable zones.

According to another aspect of the present disclosure, a method of making a light emitting device is provided, which comprises the steps of: transferring light emitting diodes to a substrate including a support circuitry to form an assembly of light emitting diodes; bonding a molded frame to the assembly of light emitting diodes; and filling gaps in the molded frame and over the array of light emitting diodes with a transparent plastic material to form a sub-panel.

According to an aspect of the present disclosure, a method of operating a liquid crystal display module which includes a plurality of liquid crystal pixels and a backlight unit comprising plurality of white-light-emitting LEDs located in a plurality of individually dimmable zones, comprises selectively brightening or dimming one or more individually dimmable zones to directly illuminate one or more pixels with brighter or dimmer white light.

### BRIEF DESCRIPTION OF THE DRAWINGS

FIG. 1 is a schematic illustration of the step of generation of assemblies of growth substrates with respective devices thereupon from initial growth substrates according to an embodiment of the present disclosure.

FIG. 2 is a schematic illustration of the step of bonding of the growth substrates to respective first carrier substrates through the respective devices according to an embodiment of the present disclosure.

FIG. 3 is a schematic illustration of the step of removing the growth substrates according to an embodiment of the present disclosure.

FIG. 4 is a schematic illustration of the step of forming a first bonding material layer on the first carrier substrates, providing second carrier substrate, and forming a release layer and a second bonding material layer according to an embodiment of the present disclosure.

FIG. 5 is a schematic illustration of the step of bonding each pair of a first carrier substrate and a second carrier substrate according to an embodiment of the present disclosure.

FIG. 6 is a schematic illustration of the step in which each first carrier substrate is removed from a bonded structure according to an embodiment of the present disclosure.

FIG. 7 is a vertical cross-sectional view of a supply coupon including a source substrate and devices thereupon according to an embodiment of the present disclosure.

FIG. 8 is a vertical cross-sectional view of a comparative exemplary structure that is not conducive to uniform surface-to-surface contacts between vertically facing pairs of bonding structures.

FIG. 9 is a vertical cross-sectional view of an exemplary structure including at least one set of coined bonding structures according to an embodiment of the present disclosure.

FIG. 10 is a perspective view micrograph of a set of coined bonding structures including solder material portions according to an embodiment of the present disclosure.

FIGS. 11A-11H are sequential vertical cross-sectional views of a target substrate and transferred devices during various steps of the transfer process according to an embodiment of the present disclosure.

FIGS. 12A and 12B are sequential vertical cross-sectional views of a target substrate, a transferred device, and bonding structures therebetween during a first exemplary bonding process according to an embodiment of the present disclosure.

FIGS. 13A and 13B are sequential vertical cross-sectional views of a target substrate, a transferred device, and bonding structures therebetween during a second exemplary bonding process according to an embodiment of the present disclosure.

FIGS. 14A-14C are sequential vertical cross-sectional views of a target substrate, a transferred device, and bonding structures therebetween during a third exemplary bonding process according to an embodiment of the present disclosure.

FIG. 15 is a schematic diagram illustrating an assembly of backlight illumination unit according to an embodiment of the present disclosure.

FIG. 16 is a diagram illustrating an assembly process for a sub-panel according to an embodiment of the present disclosure.

FIG. 17 is a perspective view of a backlight illumination unit in which components are individually illustrate.

FIG. 18 is a schematic diagram illustrating an assembly of backlight illumination unit according to an embodiment of the present disclosure.

### DETAILED DESCRIPTION

As stated above, the present disclosure is directed to an assembly of integrated back light units, and a method of manufacturing the same, the various aspects of which are described below. Throughout the drawings, like elements are described by the same reference numeral. The drawings are not drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure.

As used herein, a “light emitting device” refers to any device that is configured to emit light and includes, but is not limited to, a light emitting diode (LED), a laser, such as a vertical-cavity surface-emitting laser (VCSEL), and any other electronic device that is configured to emit light upon application of a suitable electrical bias. A light emitting device may be a vertical structure (e.g., a vertical LED) in which the p-side and n-side contacts are located on opposite sides of the structure or a lateral structure in which the p-side and n-side contacts are located on the same side of the structure. As used herein, a “light emitting device assembly” refers to an assembly in which at least one light emitting device is structurally fixed with respect to a support structure, which can include, for example, a substrate, a matrix, or any other structure configured to provide stable mechanical support to the at least one light emitting device.

In the present disclosure, a method is provided for transferring an array of devices (such as an array of light emitting devices or an array of sensor devices) from a growth substrate to a target substrate. The target substrate may be any substrate on which formation of multiple types of devices in any configuration is desired. In an illustrative example, the target substrate may be a backplane substrate such as an active or passive matrix backplane substrate for driving light emitting devices. As used herein, a “backplane substrate” refers to any substrate configured to affix multiple devices thereupon. In one embodiment, the center-to-center spacing of neighboring light emitting devices on the backplane substrate can be is an integer multiple of the center-to-center spacing of neighboring light emitting devices on the growth substrate. The light emitting devices may include a plurality of light emitting devices, such as a group of two light emitting devices, one configured to emit blue light and one configured to emit green light. The light emitting devices may include a group of three light emitting devices, one configured to emit blue light, one configured to emit green light, and one configured to emit red light. As used herein, “neighboring light emitting devices” refer to a plurality of two or more light emitting devices located in closer proximity than at least another light emitting device. The method of the present disclosure can provide selective transfer of a subset of light emitting devices from a light emitting device array on a growth substrate to the backplane substrate.

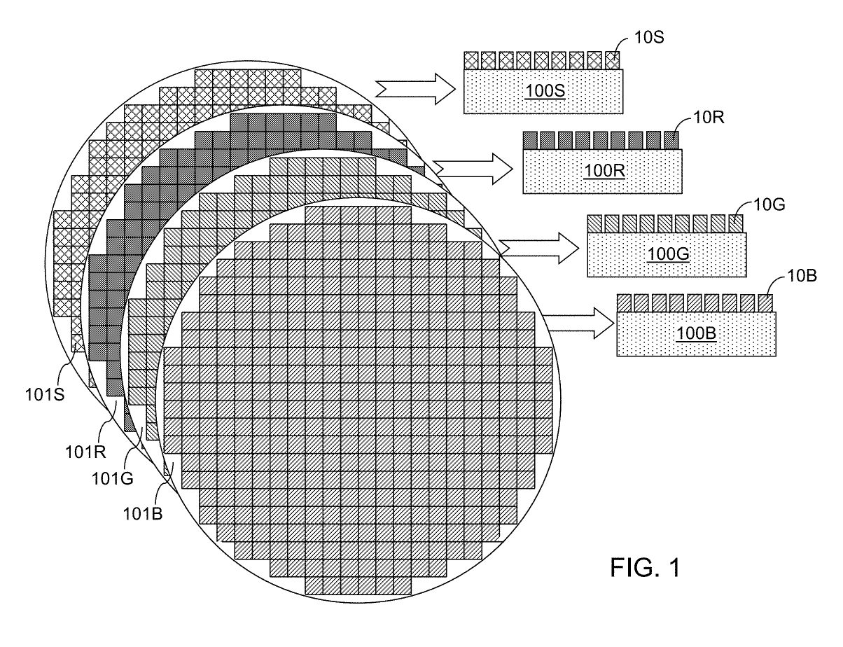

Referring to FIG. 1, devices (10B, 10G, 10R, 10S) can be fabricated on respective initial growth substrates (101B, 101G, 101R, 101S) employing methods known in the art. As used herein, an “initial growth substrate” refers to a substrate that is processed to form devices thereupon or therein. The devices (10B, 10G, 10R, 10S) can include light emitting devices (10B, 10G, 10R) and/or sensor devices 10S (e.g., photodetectors) and/or any other electronic devices. The light emitting devices (10B, 10G, 10R) can be any type of light emitting devices, i.e., vertical light emitting devices, lateral light emitting devices, or any combination thereof. Devices of the same type can be formed on each initial growth substrate (101B, 101G, 101R, 101S). The devices (10B, 10G, 10R, 10S) can be formed as an array on the respective initial growth substrates (101B, 101G, 101R, 101S).

In one embodiment, the initial growth substrates (101B, 101G, 101R, 101S) can include an absorbing substrate such as a silicon substrate. As used herein, an “absorbing substrate” refers to a substrate that absorbs more than 50% of light energy within the spectrum range including ultraviolet range, visible range, and infrared range. As used herein, “ultraviolet range” refers to the wavelength range from 10 nm to 400 nm; “visible range” refers to the wavelength range from 400 nm to 800 nm, and “infrared range” refers to the wavelength range from 800 nm to 1 mm

If the initial growth substrates (101B, 101G, 101R, 101S) are absorbing substrates, each array of devices (10B, 10G, 10R, 10S) can be transferred to a respective transparent carrier substrates, or a “transparent substrate,” by full wafer transfer processes in which each array of devices (10B, 10G, 10R, 10S) is transferred to the respective transparent substrate in its entirety. As used herein, a “transparent substrate” refers to a substrate that transmits more than 50% of light energy at a wavelength within the spectrum range including ultraviolet range, visible range, and infrared range.

In one embodiment, devices (10B, 10G, 10R, 10S) can include light emitting devices (10B, 10G, 10R). In one embodiment, each light emitting device (10B, 10G, 10R) can be configured to emit light of a single peak wavelength. It is understood that light emitting devices typically emit light of a narrow wavelength band centered around the single wavelength at which the intensity of light is at a maximum, and the wavelength of a light emitting device refers to the peak wavelength. For example, an array of first light emitting devices 10B can be formed on a first-type growth substrate 100B, an array of second light emitting devices 10G can be formed on a second-type growth substrate 100G, and an array of third light emitting devices 10R can be formed on a third-type growth substrate 100R. In addition, an array of sensor devices 10S can be formed on a fourth-type growth substrate 100S. Alternatively, one or more types of light emitting devices (10B, 10G, 10R) can be integrated light emitting devices that are configured to emit light of at least two different wavelengths. In one embodiment, the light emitting devices (10B, 10G, 10R) may comprise arrays of nanowires or other nanostructures.

Contact structures (not explicitly shown) such as contact pads are provided on each light emitting device (10B, 10G, 10R). The contact structures for each light emitting device (10B, 10G, 10R) can include an anode contact structure and a cathode contact structure. In case one or more of the light emitting devices (10B, 10G, 10R) is an integrated light emitting device configured to emit light of at least two different wavelengths, a common contact structure (such as a common cathode contact structure) can be employed. For example, a triplet of blue, green, and red light emitting devices embodied as a single integrated light emitting device may have a single cathode contact.

The array of light emitting devices (10B, 10G, 10R) on each initial growth substrate (101B, 101G, 101R) is configured such that the center-to-center spacing of light emitting devices on a backplane substrate to which the light emitting devices are subsequently transferred is an integer multiple of the center-to-center spacing of light emitting devices (10B, 10G, 10R) on the initial growth substrate (101B, 101G, 101R).

Each initial growth substrate (101B, 101G, 101R, 101S) and devices (10B, 10G, 10R, 10S) thereupon can be diced into suitable sizes. Each diced portion of the initial growth substrate (101B, 101G, 101R, 101S) is herein referred to as a growth substrate (100B, 100G, 100R, 100S). Assemblies of growth substrates (100B, 100G, 100R, 100S) with respective devices (10B, 10G, 10R, 10S) thereupon are thus generated. In other words, the growth substrates (100B, 100G, 100R, 100S) are either the entirety or the diced portions of the initial growth substrates (101B, 101G, 101R, 101S), and an array of devices (10B, 10G, 10R, 10S) is present on each growth substrate (100B, 100G, 100R, 100S). The array of devices (10B, 10G, 10R, 10S) on each growth substrate (100B, 100G, 100R, 100S) can be an array of devices of the same type.

Prior to, or after, each initial growth substrate (101B, 101G, 101R, 101S) is singulated to corresponding growth substrates (100B, 100G, 100R, 100S), each device (10B, 10G, 10R, 10S), e.g., a light emitting device, a group of light emitting devices, or a sensor device, can be mechanically isolated from one another by forming trenches between each neighboring pair of the devices. In an illustrative example, if a light emitting device array or a sensor array is disposed on an initial growth substrate (101B, 101G, 101R, 101S), the trenches can extend from the final growth surface of the light emitting device array or the sensor array to the top surface of the initial growth substrate (101B, 101G, 101R, 101S).

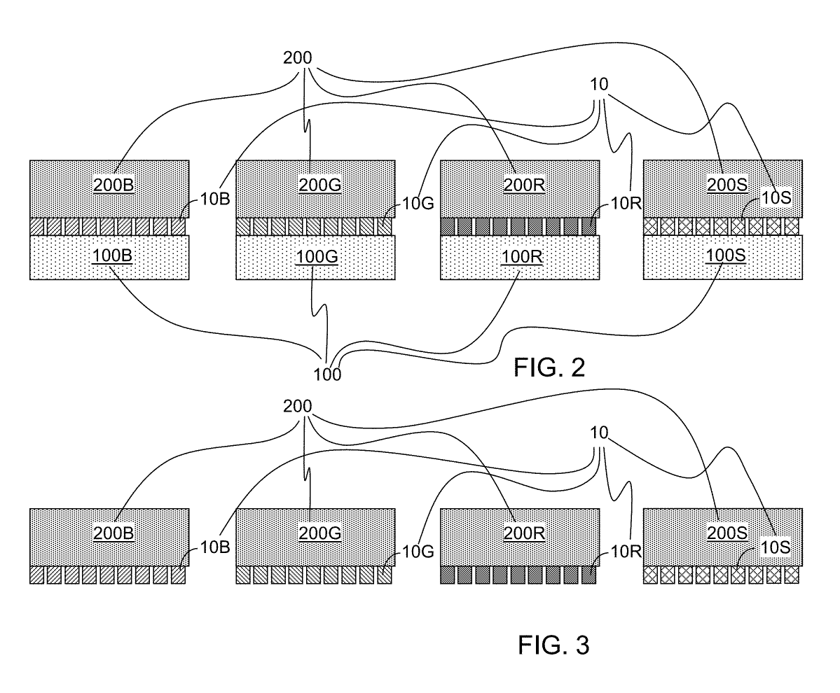

Various schemes may be employed to transfer each array of devices (10B, 10G, 10R, 10S) to a respective transparent substrate. FIGS. 2-6 illustrate an exemplary scheme that can be employed to transfer each array of devices (10B, 10G, 10R, 10S) to a respective transparent substrate.

Referring to FIG. 2, first carrier substrates 200 can be optionally employed in case the contact structures on each device (10B, 10G, 10R, 10S) are formed on the top side of each device (10B, 10G, 10R, 10S) during fabrication of the devices (10B, 10G, 10R, 10S) on the growth substrates (101B, 101G, 101R, 101S). The first carrier substrates 200 can be any suitable substrate that can be bonded to the devices (10B, 10G, 10R, 10S) and can provide structural support to the (10B, 10G, 10R, 10S). Each as-grown array of devices (10B, 10G, 10R, 10S) and a respective growth substrate 100 is bonded to a first carrier substrate 200. Thus, each growth substrate 100 can be bonded to a respective first carrier substrate 200 through the respective devices 10. In other words, the devices 10 are present between a growth substrate 100 and a first carrier substrate within each bonded structure (100, 10, 200). In an illustrative example, a first-type growth substrate 100B can be bonded to a first-type first carrier substrate 200B through first light emitting devices 10B, a second-type growth substrate 100G can be bonded to a second-type first carrier substrate 200G through second light emitting devices 10G, a third-type growth substrate 100R can be bonded to a third-type first carrier substrate 200R through third light emitting devices 10R, and a fourth-type growth substrate 100S can be bonded to a fourth-type first carrier substrate 200S through the sensor devices 10S.

Referring to FIG. 3, each growth substrate 100 can be removed from the transient bonded structure including the stack of the growth substrate 100, an array of devices 10, and the first carrier substrate 200. For example, if the growth substrate 100 is a silicon substrate, the growth substrate 100 can be removed by a wet chemical etch process, grinding, polishing, splitting (for example, at a hydrogen implanted layer), or a combination thereof. For example, splitting of a substrate can be performed by implanting atoms that form a weak region (such as hydrogen atoms implanted into a semiconductor material) and by applying a suitable processing conditions (for example, an anneal at an elevated temperature and/or mechanical force) to cause the substrate to split into two parts.

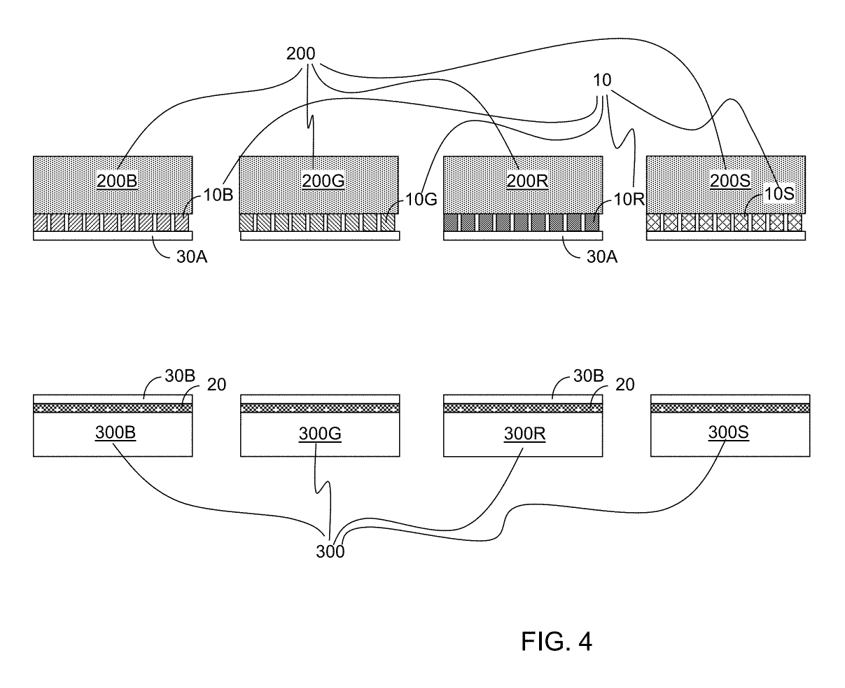

Referring to FIG. 4, a first bonding material layer 30A can be formed on each first carrier substrate 200. The first bonding material layer 30A includes any bonding material that can be bonded to another bonding material upon suitable treatment (such as application of heat and/or pressure). In one embodiment, the first bonding material layer 30A can comprise a dielectric material such as silicon oxide, borophosphosilicate glass (BPSG), a spin-on glass (SOG) material, and/or an adhesive bonding material such as SU-8 or benzocyclobutene (BCB). The thickness of the first bonding material layer 30A can be in a range from 50 nm to 5 micron, although lesser and greater thicknesses can also be employed. In one embodiment, the first bonding material layer 30A can be a silicon oxide layer having a thickness of about 1 micron. The first bonding material layer 30A can be formed by a suitable deposition method such as chemical vapor deposition or spin coating.

Transfer substrates 300 are provided. As used herein, a “transfer substrate” refers to a substrate from which at least one device is transferred to a target substrate, which can comprise a backplane substrate. In one embodiment, each transfer substrate 300 can be a second carrier substrate, which can be employed to receive an array of devices from a respective first carrier substrate 200 and to carry the array of devices until a subset of the devices are transferred to the target substrate in a subsequent process.

In some embodiments, the transfer substrates 300 can be optically transparent at a laser wavelength. The laser wavelength is the wavelength of the laser beam to be subsequently employed to transfer devices individually and selectively from a respective transfer substrate 300 to the target substrate, and can be an ultraviolet wavelength, a visible wavelength, or an infrared wavelength. In one embodiment, the transparent substrates 300 can include sapphire, glass (silicon oxide), or other optically transparent material known in the art. In an alternative embodiment, the transfer substrates 300 can be transparent growth substrates or diced portions thereof. In some other embodiments in which initial growth substrates are cleaved (for example, at a layer implanted with hydrogen or noble gas) to provide a thin substrate from which light emitting diodes are transferred to a backplane without use of transfer substrates, the initial growth substrates may absorb laser at the laser wavelength.

A release layer 20 and a second bonding material layer 30B can be sequentially deposited on each transfer substrate 300. The release layer 20 includes a material that can provide sufficient adhesion to the transfer substrate 300 and is absorptive at the laser wavelength of the laser beam to be subsequently employed during a subsequent selective transfer process. For example, the release layer 20 can include silicon-rich silicon nitride or a semiconductor layer, such as a GaN layer that can be heated by laser irradiation. The thickness of the release layer 20 can be in a range from 100 nm to 1 micron, although lesser and greater thicknesses can also be employed.

The second bonding material layer 30B can comprise a dielectric material such as silicon oxide. The thickness of the second bonding material layer 30B can be in a range from 50 nm to 5 micron, although lesser and greater thicknesses can also be employed. In one embodiment, the second bonding material layer 30B can be a silicon oxide layer having a thickness of about 1 micron. The second bonding material layer 30B can be formed by a suitable deposition method such as chemical vapor deposition or spin coating.

A transfer substrate 300 can be provided for each first carrier substrate 200. For example, a first transfer substrate 300B can be provided for the first-type first carrier substrate 200B; a second transfer substrate 300G can be provided for the second-type first carrier substrate 200G; a third transfer substrate 300R can be provided for the third-type first carrier substrate 300R; and an additional transfer substrate 300S can be provided for the additional type first carrier substrate 300S. Multiple stacked structures can be formed, which include a first stacked structure (300B, 20, 30B) including a stack of the first transfer substrate 300B, a release layer 20, and a second bonding material layer 30B; a second stacked structure (300G, 20, 30B) including a stack of the second transfer substrate 300G, a release layer 20, and a second bonding material layer 30B; a third stacked structure (300R, 20, 30B) including a stack of the third transfer substrate 300R, a release layer 20, and a second bonding material layer 30B; and an additional stacked structure (300S, 20, 30B) including a stack of the additional transfer substrate 300S, a release layer 20, and a second bonding material layer 30B.

The combination of the array of first light emitting devices 10B and the first transfer substrate 300B is herein referred to as a first transfer assembly (300B, 10B), the combination of the second light emitting devices 10G and the second transfer substrate 300G is herein referred to as a second transfer assembly (300G, 10G), and the combination of the third light emitting devices 10R and the third transfer substrate 300R is herein referred to as a third transfer assembly (300R, 10R). In addition, the combination of the sensor devices 10S and the fourth transfer substrate 300S is herein referred to as fourth transfer assembly (300S, 10S).

Referring to FIG. 5, each pair of a first carrier substrate 200 and a transfer substrate 300 (which can be a second carrier substrate) can be bonded. For example, the second bonding material layer 30B can be bonded with the respective first bonding material layer 30A on the corresponding first carrier substrate 200 to form a bonding material layer 30. Each bonded assembly comprises a first transfer substrate 300, a release layer 20, a bonding material layer 30, and an array of devices 10.

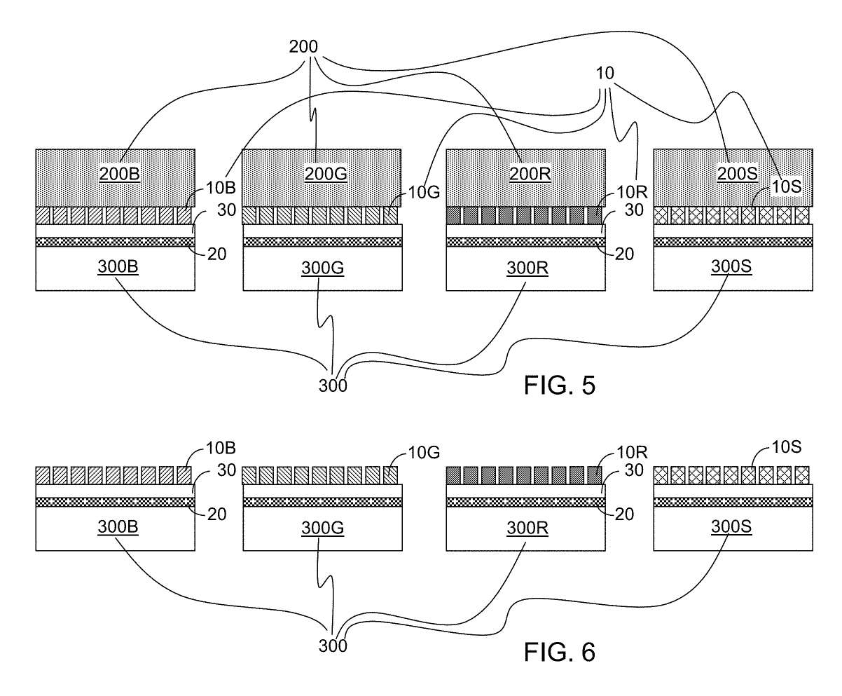

Referring to FIG. 6, a first carrier substrate 200 is removed from each bonded assembly (300, 20, 30, 200), for example, by polishing, grinding, cleaving, and/or chemical etching. Each array of devices 20 can be disposed on a transfer substrate 300, which is a transparent carrier substrate with a release layer 20 thereupon, i.e., between the transparent carrier substrate and the array of devices 20.

Generally speaking, an array of devices can be provided on a source substrate such that each device is laterally spaced from neighboring devices by trenches. The combination of the array of devices and the source substrate constitutes a source coupon from which the devices can be subsequently transferred to a target substrate.

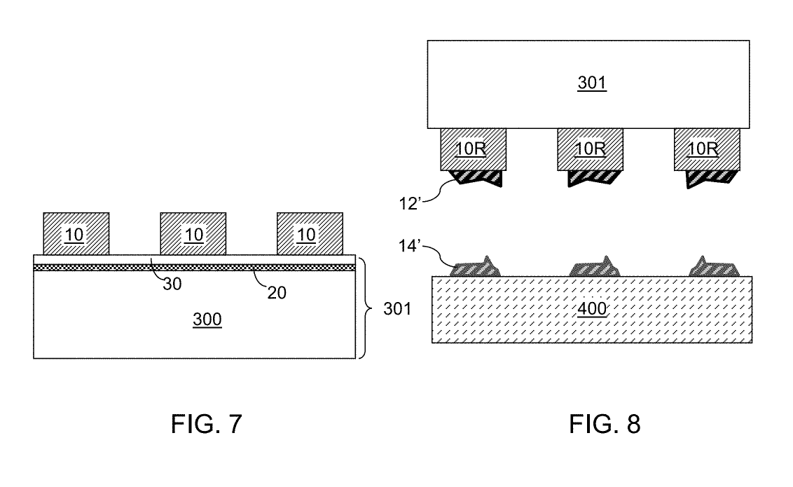

Referring to FIG. 7, an exemplary source coupon (301, 10) is illustrated, which includes a source substrate 301 and an array of devices 10. The devices 10 can be selected from light emitting diodes and semiconductor sensor devices. For example, the diodes 10 may be light emitting diodes that emit light of a same wavelength (i.e., a light spectrum centered at the same wavelength) or a semiconductor sensor device of a same type that senses the same type of input (e.g., pressure sensor, electrical current sensor, etc.) In an illustrative example, the devices 10 may be red light emitting diodes, green light emitting diodes, or blue light emitting diodes. In one embodiment, the devices 10 on the source substrate 301 can be arranged in a two-dimensional periodic array.

The source substrate 301 may be any type of substrate described above provided that the source substrate 301 can have the array of devices 10 thereupon. In one embodiment, the source substrate 301 may be any of an initial growth substrate (101B, 101G, 101R, or 101S), a first carrier substrate 200, or a transfer substrate 300. In an illustrative embodiment, source substrate 301 can be an initial growth substrate (101B, 101G, 101R, or 101S), and the devices 10 can be manufactured on the source substrate 301 by performing deposition processes and patterning processes directly on the source substrate 301 and subsequently dicing patterned structures on the source substrate 301. In another illustrative embodiment, the source substrate 301 may be a first carrier substrate 200 or a transfer substrate 300 containing a release layer 20 and/or a bonding material layer 30, and the devices 10 can be manufactured on an initial growth substrate (101B, 101G, 101R, or 101S) by performing deposition processes and patterning processes directly on the initial growth substrate (101B, 101G, 101R, or 101S), subsequently dicing patterned structures on the initial growth substrate (101B, 101G, 101R, or 101S), and transferring the diced patterned structures to the source substrate 301 either directly or indirectly through an intermediate substrate.

Referring to FIG. 8, a comparative exemplary structure is provided, which includes a source coupon and a target substrate 400 to which the devices 10 are to be transferred. As used herein, a “target substrate” refers to substrate to which an element is transferred, i.e., a substrate that functions as a destination of transferred element. The target substrate 400 includes bonding sites at which devices 10 can be bonded to the target substrate 400. Bonding materials (12′, 14′) can be applied to the facing surfaces of the devices 10 and the target substrate 400. As used herein, bonding materials include elemental metals and metal alloys which has a relatively low melting temperature, such as a temperature below 450° C., including tin, indium, alloys thereof, etc. These bonding materials are referred to as “solder” materials for ease of description herein. However, as used herein solder materials are not limited to tin-lead alloys. A general issue when solder material is applied to any surface is that the top surfaces of the solder material portions are generally non-planar, and contact between non-planar surfaces can lead to non-uniform contact and heat transfer between the pairs of the solder material portions across different bonding sites.

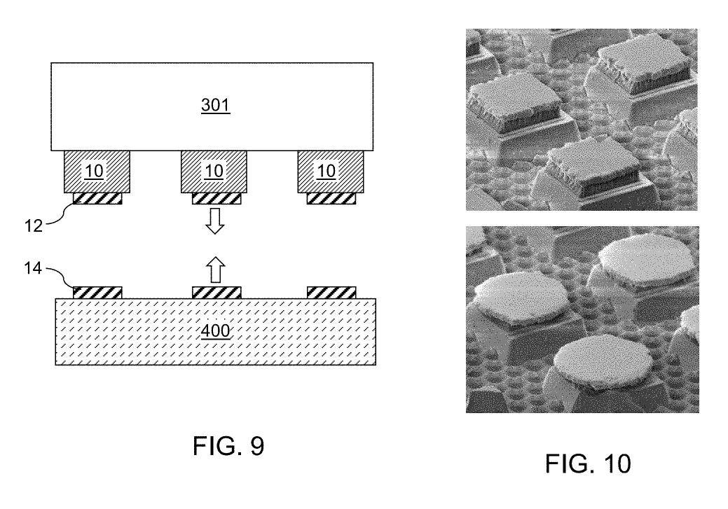

Referring to FIGS. 9 and 10, coining can be performed to at least one set of bonding structures (12, 14) located on the respective devices 10 or the target substrate 400. As used herein, “coining” refers to the act of flattening exposed surfaces of the bonding structures (12, 14). The exposed surfaces of the bonding structures may be flattened by being pressed against each other (i.e., pressing structure 12 against structure 14 as shown by the arrows in FIG. 9), preferably at above room temperature. Alternatively, the exposed surfaces of the bonding structures may be flattened by being pressed against another flat surface, such as a press mold surface, preferably at above room temperature. FIG. 9 schematically shows the configuration of a supply coupon with first bonding structures 12 thereupon that faces the target substrate 400 with second bonding structures 14 thereupon. FIG. 10 shows micrographs of coined bonding structures, which can be employed as the first bonding structures 12 if formed on devices 10 or as the second bonding structures 14 if coined on the target substrate 400.

Generally, the first bonding structures 12 can be formed on a set of surfaces of the devices 10, and the second bonding structures 14 can be formed on a set of surfaces of the bonding sites of the target substrate 400. Optionally, each of the first bonding structures 12 may include a first wetting layer (not shown), and each of the second bonding structures 14 may include a second wetting layer (not shown).

The first bonding structures 12 and/or the second bonding structures 14 include a solder material. As used herein, a “solder material” refers to a filler material, such as an electrically conductive material, for example, a metal that can be melted and flowed into a joint region between two electrically conductive portions (e.g., electrodes on the devices 10 and/or on the substrate 400) that do not melt at the temperature at which the filler material melts and reflows. A first set of solder material portions are formed on a first set of surfaces. The first set of surfaces is selected from a set of surfaces of the devices 10 and a set of surfaces of the bonding sites of the target substrate 400. In one embodiment, the first set of solder material portions may be present in the first bonding structures 12. In another embodiment, the first set of solder material portions may be present in the second bonding structures 14.

In one embodiment, the first set of solder material portions can be coined into a set of solder material pads having a uniform height, which may be selected from a range from 100 nm to 30 microns, although lesser and greater thicknesses can also be employed. In one embodiment, the first set of solder material portions and the set of solder material pads can be formed on the set of surfaces of the devices 10. In another embodiment, the first set of solder material portions and the set of solder material pads can be formed on the set of surfaces of the bonding sites of the source substrate 400.

Optionally, a second set of solder material portions can be formed on a second set of surfaces different from the first set of surfaces. The second set of surfaces can be selected from the set of surfaces of the devices 10 and the set of surfaces of the bonding sites of the source substrate 400. In this case, one set of surfaces selected from the set of surfaces of the devices 10 and the set of surfaces of the bonding sites of the source substrate 400 can be the first set of surfaces on which the first set of solder material portions is formed, and the other set of surfaces selected from the set of surfaces of the devices 10 and the set of surfaces of the bonding sites of the source substrate 400 can be the second set of surfaces on which the second set of solder material portions is formed. In this case, the second set of solder material portions can be coined into the respective bonding structures having another uniform height that may, or may not, be the same as the uniform height of the first set of solder material portions.

In one embodiment, a set of bonding structures selected from the first bonding structures 12 and the second bonding structures 14 is coined to form the solder material portions. For example, structures 12 may be pressed against structures 14 using a press. For example, the coining force of 10 to 60 Newtons, such as 20 to 50 Newtons may be applied for 1 to 60 seconds, such as 10 to 30 seconds, at above room temperature to press the substrates 301 and 400 together while structures 12 and 14 contact each other. The coining temperature may be 50 to 90 percent of the melting temperature of the material of the structures 12 and 14. For example, for tin structures 12 and 14, the coining temperature may be between 200 and 230° C. The coined set of bonding structures has the uniform height. In one embodiment, the first bonding structures 12 comprise at least a subset of the solder material portions. Alternatively or additionally, the second bonding structures 14 can comprise at least a subset of the solder material portions.

In one embodiment, the first set of solder material portions can be coined into the set of solder material pads by applying a pressure in a range from 0.5×10⁶ Pascal to 2.0×10⁷ Pascal, and/or in a range from 1.0×10⁶ Pascal to 1.2×10⁷ Pascal, and/or in a range from 1.5×10⁶ Pascal to 6.0×10⁶ Pascal. If the second set of solder material portions is employed, the second set of solder material portions can be coined into the set of solder material pads by applying a pressure in a range from 0.5×10⁶ Pascal to 2.0×10⁷ Pascal, and/or in a range from 1.0×10⁶ Pascal to 1.2×10⁷ Pascal, and/or in a range from 1.5×10⁶ Pascal to 6.0 x 10⁶ Pascal. The above pressure ranges translate to force ranges when the total area of the coined set of solder material portions is provided. In an illustrated example, the force may be in a range from 20 N for a low density, smaller display to 1 kN for a larger display (e.g., 2″ in size) with a high dots per inch (dpi) count.

In one embodiment, the target substrate 400 can be a backplane substrate for an direct view LED display panel configured to support an array of light emitting devices. Generally, the target substrate 400 is a substrate onto which various devices can be subsequently transferred. In one embodiment, the target substrate 400 can be a substrate of silicon, glass, plastic, and/or at least other material that can provide structural support to the devices to be subsequently transferred thereupon. In one embodiment, the target substrate 400 may be a passive backplane substrate, in which metal interconnect structures comprising metallization lines are present, for example, in a criss-cross grid and active device circuits are not present. In another embodiment, the target substrate 400 may be an active backplane substrate, which includes metal interconnect structures as a criss-cross grid of conductive lines and further includes a device circuitry at one or more intersections of the criss-cross grid of conductive lines. The device circuitry can comprises one or more transistors.

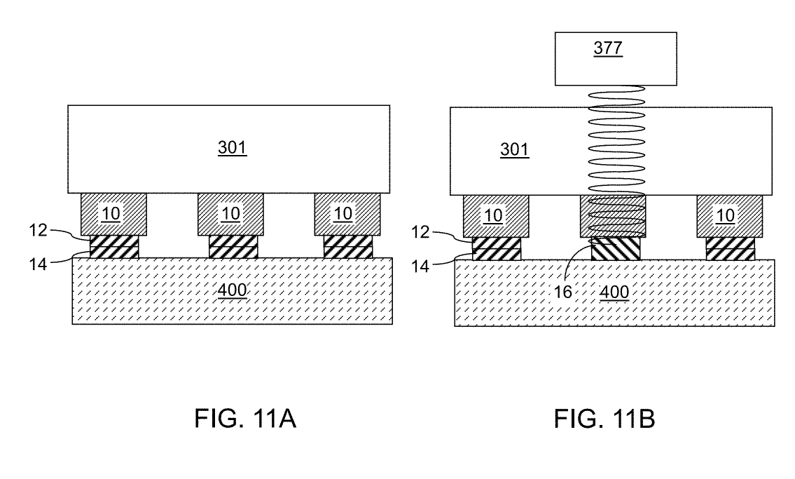

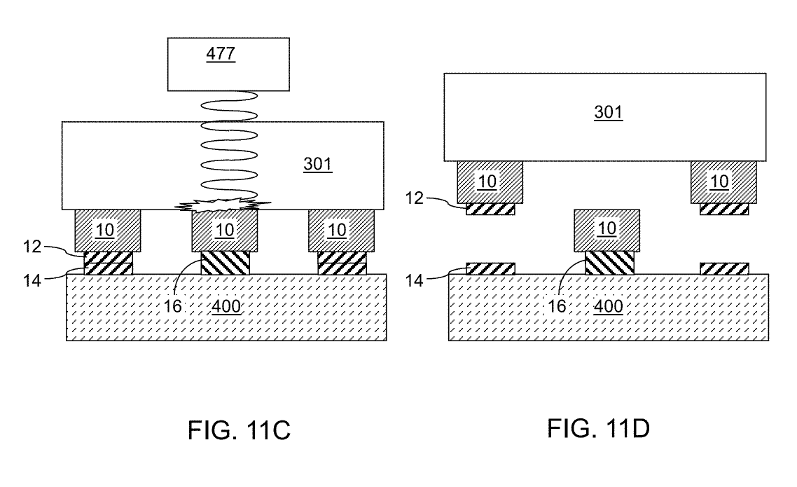

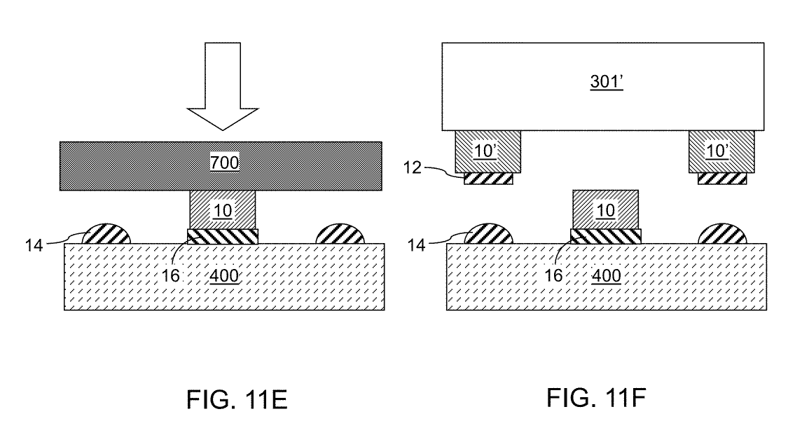

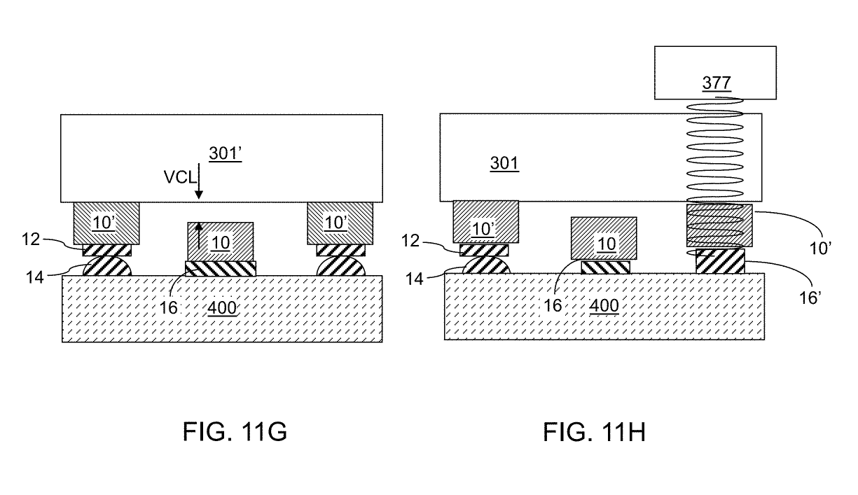

FIGS. 11A-11H illustrate vertical cross-sectional views of the target substrate 400 and devices prior to, during, or after transfer.

Referring to FIG. 11A, the first bonding structures 12 and the second bonding structures 14 are brought into contact with each other so that an adjoining pair of a first bonding structure 12 and a second bonding structure 14 is formed at each bonding site on the substrate 400. In one embodiment, planar contact surfaces can be formed between the first set of solder (i.e., bonding) material pads (as embodied by the first bonding structures 12 or the second bonding structures 14) with respective bonding structures (as embodied by the bonding structures that the solder material pads contact). The first set of solder material pads are located on one of the supply coupon and the target substrate 400, and the respective bonding structures are located on another of the supply coupon and the target substrate 400.

In one embodiment, both the first bonding structures 12 and the second bonding structures 14 include coined solder (i.e., bonding) materials. In this case, the respective bonding structures comprise the material of the second set of solder material portions. The planar contact surfaces are formed between the first bonding structures 12 and the second bonding structures 14 such that each adjoining pair of a first bonding structure 12 and a second bonding structure 14 includes two solder material portions.

In one embodiment, only one set of bonding structures selected from the first bonding structures 12 and the second bonding structures 14 includes a solder (i.e., bonding) material. In this case, the respective bonding structures comprise a metallic material that is not a solder material. The planar contact surfaces are formed between the first bonding structures 12 and the second bonding structures 14 such that each adjoining pair of a first bonding structure 12 and a second bonding structure 14 includes one solder material portion.

Referring to FIG. 11B, a subset of the devices 10 can be bonded to a subset of the bonding sites of the target substrate 400 by reflowing a subset of the solder material pads underlying or overlying the subset of the devices 10. In one embodiment, a subset of adjoining pairs of a first bonding structure 12 and a second bonding structure 14 can be sequentially bonded by sequentially reflowing respective at least one solder material portion (as embodied as a portion of a first bonding structure 12 and/or a portion of a second bonding structure 14) without reflowing a complementary subset of bonding structures (12, 14) of the adjacent devices 10. The complementary subset can be a non-empty set. A first subset of the devices 10 can be bonded to a first subset of the bonding sites of the target substrate 400 at each bonding site at which bonding is performed, while a second (complementary) subset of the devices 10 is not bonded to a second (complementary) subset of the bonding sites of the target substrate 400 at each bonding site at which bonding is not performed. In one embodiment, the selection of the bonding site at which boning is performed can be selected such that the bonded devices 10 form a periodic array.

In one embodiment, the reflowing of the subset of the solder material pads (as embodied as a portion of a first bonding structure 12 and/or a portion of a second bonding structure 14) can be performed by irradiating a laser beam from laser 377 on each solder material pads to be reflowed. The wavelength of the laser beam can be selected such that the laser beam passes through the source substrate 301 and the devices 10. In this case, the laser beam can pass through the source substrate 301 and a respective device 10 before illumination on each solder material pad. Alternatively, if the target substrate 400 includes a material though which the laser beam passed without significant absorption, the laser beam can pass through the target substrate 400. In one embodiment, the wavelength of the laser beam can be in a visible light range (i.e., a wavelength range from 400 nm to 800 nm) or in the infrared range.

A bonded solder material portion 16 is formed by reflow of each solder material pad formed by coining and optionally, if present, by reflow of any additional solder material that may not have been coined. Each bonded solder material portion 16 includes a reflowed and re-solidified solder material and additionally includes a pair of metal pads (not separately shown) that are attached to the target substrate 400 and a respective device 10.

Referring to FIG. 11C, the subset of the devices 10 that are bonded to the target substrate 400 can be detached from the source substrate 301 such that the subset of the devices 10 is transferred to the target substrate 400. In one embodiment, the detachment of the subset of the devices 10 can be performed by sequential laser irradiation from layer 477 and heating of the surface portions of the source substrate 301 that contacts the subset of the devices 10 that are bonded to the target substrate 400. In an illustrative example, the source substrate 301 can include a release layer (such as the release layer 20 illustrated in FIG. 7). The release layer can include silicon-rich silicon nitride or a semiconductor layer, such as a GaN layer that can be heated by laser irradiation.

In one embodiment, each device 10 bonded to the target substrate 400 can be detached employing targeted laser irradiation emitted by a laser 477. The material of the surface portion of the source substrate 301 that is proximal to the devices 10 can be selected such that the laser beam is absorbed by the surface portion of the source substrate 301. The size of the laser beam, or the size of the raster area of the laser beam if the laser beam is rastered, can be selected to substantially match the area of each device 10 to be detached. In one embodiment, the irradiated surface portion of the source substrate 301 (e.g., the release layer 20) can be ablated. In one embodiment, the surface portion of the source substrate 301 can comprise silicon nitride, the laser wavelength of the laser beam can be an ultraviolet wavelength (such as 248 nm or 193 nm), and irradiating the surface portions with the laser beam ablates the surface portions. Preferably the peak wavelength of the beam from laser 377 is longer than the peak wavelength of the beam from laser 477.

Referring to FIG. 11D, the remaining portions of the source coupon, i.e., the assembly of the source substrate 301 and devices 10 that remain attached to the source substrate 301, are separated from the assembly of the target substrate 400 and the devices 10 bonded thereto through respective bonded solder material portions 16.

Referring to FIG. 11E, at least one of the target substrate 400 and the transferred subset of the devices 10 can be pushed against each other while performing an additional reheating and reflow of solder material portions (i.e., the bonded solder material portions 16) that are present on the target substrate 400. For example, the top surfaces of the bonded devices 10 may be pushed toward the target substrate 400 employing a planar substrate or press die 700 having a horizontal bottom surface, which can contact the top surfaces of the transferred devices 10.

Optionally, the re-heating process can induce reflow of the remaining second bonding structures 14 which are not bonded to devices 10. The unbounded structures 14 may melt and reflow to develop convex surface profiles. The reflowed and re-solidified second bonding structures 14 may have a greater thickness (i.e., height) at a center portions thereof than the second bonding structures 14 prior to the reflow, such as at least 50%, for example 50-100% greater thickness (i.e., height). The reflowed and re-solidified second bonding structures 14 preferably also have a greater thickness (i.e., height) at a center portions thereof than the bonded material structures 16 which are bonded to the devices 10, such as at least 50%, for example 50-100% greater thickness (i.e., height). The reflow temperature may be slightly higher than the melting temperature of the bonding structure, for example 15 to 20° C. higher than the melting temperature of the bonding structure. Thus, for tin bonding material structures 14 having a melting temperature of about 232° C., the reflow temperature may be 245 to 255° C. The reflow may be conducted in a reflow oven in an inert or reducing ambient (i.e., in a non-oxidizing ambient). Alternatively, the reflow may be conducted in air if an anti-oxidation flux is used during reflow.

Referring to FIG. 11F, an additional source coupon including an additional source substrate 301′ and additional devices 10′ can be provided. The additional devices 10′ can be positioned with some vacancies such that the additional devices 10′ do not collide with the devices 10 that are present on the target substrate 400. Additional first bonding structures 12 can be provided on the additional devices 10′.

Referring to FIG. 11G, the first bonding structures 12 on the additional source coupon (301′, 10′) can be brought into physical contact with the second bonding structures 14 on the target substrate 400. Because the thickness of the bonded solder material portions 16 is less than the sum of the thicknesses of a stack of a first bonding structures 12 and a second bonding structure 14, a vertical clearance VCL can be provided between the bottom surface of the additional source substrate 301′ and the top surfaces of the devices 10 that are already bonded to the target substrate 400. Subsequently, the processing steps of FIGS. 11B-11D can be performed to transfer a subset of the additional devices 10′ to the target substrate 400. The processing step of FIG. 11E can be performed again such that the top surfaces of all bonded devices (10, 10′) can be coplanar, i.e., within a same horizontal plane.

The processing steps of FIGS. 11F and 11G and the processing step of FIG. 11E can be repeated with more source coupons having different types of devices to transfer more devices to the target substrate 400, as shown in FIG. 11H.

Thus, in one embodiment, the method of FIGS. 7, 8, 9, 10 and 11A-11H includes providing a supply coupon comprising a combination of a source substrate 301 and devices 10 thereupon, providing a target substrate 400 that includes bonding sites and forming first bonding material portions 12′ on one of surfaces of the devices 10 (or alternatively on surfaces of the bonding sites of the target substrate 400), and coining the first bonding material portions 12′ to form first bonding material pads 12 having a flatter bonding surface than that of the first bonding material portions 12′, as shown in FIGS. 8 and 9.

The method further includes bonding a first set (e.g., including the middle pad 12 in FIG. 11B) of the first bonding material pads 12 with respective bonding structures 14 to form a first set of bonded material portions 16, as shown in FIG. 11B. The first set of the first bonding material pads 12 is located on a first set of devices (e.g., including the middle device 10 in FIG. 11B, or alternatively on the first set of bonding sites of the target substrate 400), and the bonding structures 14 are located on the first set (e.g., the middle bonding site in FIG. 11B) of the bonding sites of the target substrate 400 (or alternatively on the first set of devices). The method further includes detaching the first set of devices (e.g., the middle device 10 in FIGS. 11C and 11D) from the source substrate 301, such that the first set of the devices 10 is bonded to the bonding sites of the target substrate 400 by the first set of bonded material portions 16, while a remaining second set of devices 10 (e.g., the left and right devices 10 in FIG. 11D) remains on the source substrate 301.

As shown in FIG. 11A, the bonding structures 14 preferably comprise second bonding material pads 14 and as described above, the devices 10 comprise LEDs. As shown in FIGS. 8 and 9, the second bonding material pads 14 may be formed by forming second bonding material portions 14′ on the other one of surfaces of the devices 10 or surfaces of the bonding sites of the target substrate 400, and coining the second bonding material portions 14′ to form the second bonding material pads 14 having a flatter bonding surface than that of the second bonding material portions 14. Preferably, coining the first bonding material portions 12′ and coining the second bonding material portions 14′ comprises pressing the first bonding material portions against the second bonding material portions at an elevated temperature.

In another embodiment, a method comprises reflowing a second set of bonding pads 14 on a second set of the bonding sites that are not bonded to the devices 10 to increase a thickness of the second set of the bonding pads 14 without increasing a thickness of the first set of bonded material portions 16, as shown in FIG. 11E. The method further includes providing a second supply coupon comprising a combination of a second source substrate 301′ and third and fourth sets of devices 10′ thereupon, as shown in FIG. 11F. This step is followed by bonding the third set of devices 10′ (e.g., the right side device in FIG. 11H) to the second set of bonding pads 14 (e.g., the right side pad in FIG. 11H) on the second set of the bonding sites on the target substrate 400 such that a clearance space VCL exists between the second source substrate 301′ and the first set of devices 10. The bonding may be carried out by laser irradiation from the laser 377 similar to that shown in FIG. 11B to form a second bonded material portion 16′ between the devices 10′ and pads 14. The method also includes detaching the third set of devices 10′ (e.g., the right side device in FIG. 11H) from the second source substrate 301′, wherein the third set of the devices 10′ is bonded to the target substrate 400, while the fourth set of devices 10′ (e.g., the left device 10′ in FIG. 11H) remains on the second source substrate 301′, similar to the step shown in FIG. 11F.

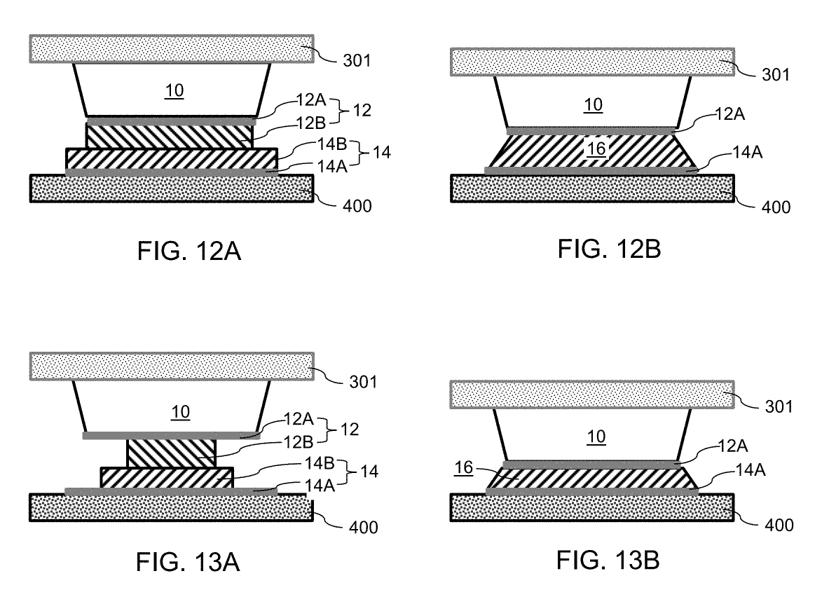

Referring to FIGS. 12A and 12B, a first exemplary bonding process is illustrated, which may be employed at the processing steps of FIGS. 11A and 11B.

Referring to FIG. 12A, first bonding structures 12 can be formed on a set of surfaces of the devices 10. Each of the first bonding structures 12 comprises a first wetting layer 12A having a first lateral dimension (e.g., a first width which in FIG. 12A is the horizontal direction which is parallel to the surface of the device 10 which faces the substrate 400 during bonding), and a first solder material pad 12B having a lateral dimension that is the same as the first lateral dimension facing substrate 400. In one embodiment, a vertically stacked pair of a first wetting layer 12A and a first solder material pad 12B can have the same area. The first solder material pad 12B can be a coined portion of a solder material. Second bonding structures 14 can be formed on a set of surfaces of the bonding sites of the target substrate 400. Each of the second bonding structures 14 comprises a second wetting layer 14A having a second lateral dimension (e.g., a second width which in FIG. 12A is the horizontal direction which is parallel to the surface of the substrate 400 which faces the device 10 during bonding) that is greater than the first lateral dimension, and a second solder material pad 14B having a lateral dimension that is the same as the second lateral dimension. In one embodiment, a vertically stacked pair of a second wetting layer 14A and a second solder material pad 14B can have the same area facing the device 10. In one embodiment, the second lateral dimension can be greater than the first lateral dimension.

The first bonding structures 12 and the second bonding structures 14 can be brought into physical contact to form vertical stacks of a first bonding structure 12 and a second bonding structure 14 having a face-to-face contact at a planar interface. In FIG. 12A, the vertical direction is perpendicular to the surfaces of the device 10 and substrate 400 which face each other. Each adjoining pair of a first bonding structure 12 and a second bonding structure 14 includes at least one solder material portion such as a first solder material pad 12B and a second solder material pad 14B. The first solder material pad 12B and a second solder material pad 14B may include any suitable bonding material, such as tin, indium, tellurium, and alloys thereof. The wetting layers 12A and 14A may comprise any suitable wetting material, such as gold, nickel or platinum. Optionally, the wetting layers may also contain additional barrier metal sublayers, such as titanium or tungsten sublayers. Preferably, the wetting layers are thinner than the pads.

Referring to FIG. 12B, a subset of adjoining pairs of a first bonding structure 12B and a second bonding structure 14B can be bonded by reflowing respective solder material portions (12B, 14B). A solder material portion 16 having a trapezoidal vertical cross-sectional profile (i.e., thickness cross section between device 10 and substrate 400) is formed between the target substrate 400 and each bonded device 10 after the reflowed solder material portions re-solidify. A subset of the devices 10 is bonded to a subset of the bonding sites of the target substrate 400. The solder (i.e., bonded) material portion 16 has a lower total height (i.e., thickness) than the sum of the heights of the starting bonding structures 12 and 14. Thus, the starting bonding structures 12 and 14 may have a non-trapezoidal vertical cross sectional profile (i.e., shape), such as a rectangular vertical cross sectional profile. After the bonding step, the resulting bonded material portion 16 has trapezoidal vertical cross-sectional profile (i.e., shape).

In one embodiment, the trapezoidal vertical cross-sectional profile can be formed by a self-aligning wetting process in which a first periphery of each reflowed solder material portion 16 is aligned to a periphery of a respective first wetting layer 12A and a second periphery of each reflowed solder material portion 16 is aligned to a periphery of a respective second wetting layer 14B by surface tension during a respective reflow process. The reflow process may be performed by an anneal process that is performed in a furnace, or can be performed site by site, for example, by laser irradiation. Optionally, the target substrate 400 and the bonded devices 10 can be pushed against each other during the respective reflow process at the processing step of FIG. 12B, or at a processing step corresponding to the step of FIG. 11E.

Referring to FIGS. 13A and 13B, a second exemplary bonding process is illustrated, which may be employed at the processing steps of FIGS. 11A and 11B.

Referring to FIG. 13A, first bonding structures 12 can be formed on a set of surfaces of the devices 10. Each of the first bonding structures 12 comprises a first wetting layer 12A having a first lateral dimension (e.g., a first width), and a first solder material pad 12B having a lesser lateral extent (i.e., smaller second lateral dimension or width) than the first lateral dimension. The first solder material pad 12B can be a coined portion of a solder material. Second bonding structures 14 can be formed on a set of surfaces of the bonding sites of the target substrate 400. Each of the second bonding structures 14 comprises a second wetting layer 14A having a third lateral dimension (e.g., a third width) that is greater than the first lateral dimension, and a second solder material pad 14B having a lesser lateral extent (i.e., smaller fourth lateral dimension or width) than the third lateral dimension. In one embodiment, the third lateral dimension can be greater than the first lateral dimension, which can be greater than the fourth lateral dimension, which can be greater than the second lateral dimension).

Referring to FIG. 13B, a subset of adjoining pairs of a first bonding structure 12B and a second bonding structure 14B can be bonded by reflowing respective solder material portions (12B, 14B). A solder material portion 16 having a trapezoidal vertical cross-sectional profile is formed between the target substrate 400 and each bonded device 10 after the reflowed solder material portions re-solidify. A subset of the devices 10 is bonded to a subset of the bonding sites of the target substrate 400. The same materials may be used as in the prior embodiment.

In one embodiment, the trapezoidal vertical cross-sectional profile can be formed by a self-aligning wetting process in which a first periphery of each reflowed solder material portion 16 is aligned to a periphery of a respective first wetting layer 12A and a second periphery of each reflowed solder material portion 16 is aligned to a periphery of a respective second wetting layer 14B by surface tension during a respective reflow process. The reflow process may be performed by an anneal process that is performed in a furnace, or can be performed site by site, for example, by laser irradiation. Optionally, the target substrate 400 and the bonded devices 10 can be pushed against each other during the respective reflow process at the processing step of FIG. 12B, or at a processing step corresponding to the step of FIG. 11E. In this embodiment, an even larger height reduction of portion 16 compared to the height of the original portions 12B and 14B may be obtained to facilitate the bonding steps shown in FIGS. 11E and 11F.

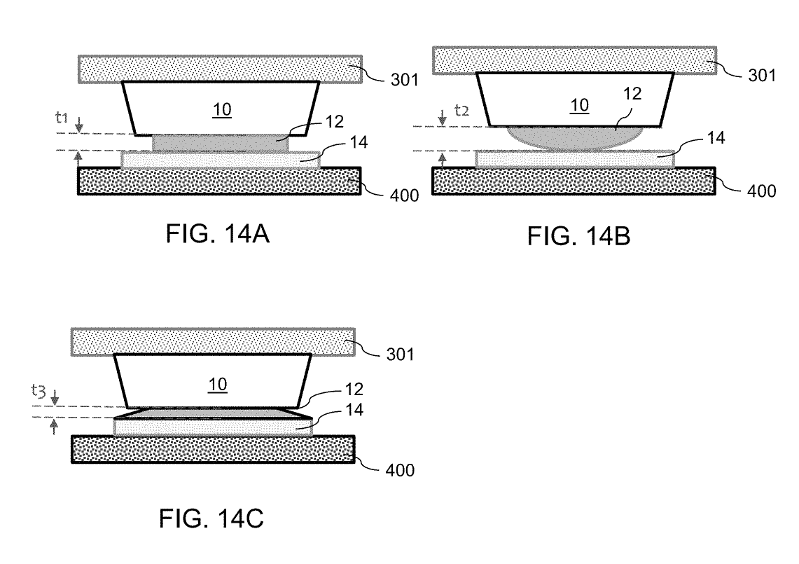

Referring to FIGS. 14A and 14B, a third exemplary bonding process is illustrated, which may be employed at the processing steps of FIGS. 11A and 11B.

Referring to FIG. 14A, first bonding structures 12 can be formed on a set of surfaces of the devices 10. The first bonding structures 12 can include a coined portion of a solder material, and can have a first lateral dimension. Second bonding structures 14 can be formed on a set of surfaces of the bonding sites of the target substrate 400. Each of the second bonding structures 14 comprises a metallic material, and can have a second lateral dimension. In one embodiment, the second lateral dimension can be greater than the first lateral dimension.

In one embodiment, each adjoining pair of the first bonding structure 12 and the second bonding structure 14 comprises two different metallic materials. In one embodiment, the at least one solder material portion that is provided within each adjoining pair of the first bonding structure 12 and the second bonding structure 14 can be a portion of a first metallic material having a lower melting temperature among the two different metallic materials. The portions of the first metallic material (e.g., of structure 12) has a first uniform height (i.e., thickness), t1, prior to reflowing of the solder material portions.

Referring to FIG. 14B, the processing step of FIG. 11B can be performed to reflow a solder material portion in each selected stack of a first bonding structure 12 and a second bonding structure 14. In one embodiment, at a first stage of reflowing, one or both solder material portions (12, 14) can develop a convex surface profile having a maximum height t2 that is greater than the first uniform height. In one embodiment, the distance between the source substrate 301 and the target substrate 400 can be increased, or can remain the same, during the first stage of reflowing. In one embodiment, a second metallic material having a higher melting temperature among the two different metallic materials is not reflowed during the reflow of the solder material portions, i.e., the first metallic material having a lower melting point. For example, structure 12 may be reflowed while structure 14 is not reflowed (or vise versa depending on the materials of the structures). For example, structure 12 may be formed of a lower melting temperature solder material, such as tin, while structure 14 may be formed of a higher melting temperature solder material, such as indium, tellurium or a gold-tin alloy. The reflow temperature may be higher than the melting temperature of the material of structure 12 but lower than the melting temperature of structure 14 to reflow only structure 12 but not structure 14.

Referring to FIG. 14C, the distance between the source substrate 301 and the target substrate 400 can be reduced during a second stage of the reflow process, or at a subsequent processing step that corresponds to the processing step of FIG. 11E (i.e., pressing the substrates 301 and 400 together). In this case, each solder material portion can develop a trapezoidal vertical cross-sectional profile while the distance between the target substrate 400 and an overlying or underlying device 10 is decreased. The height t3 of resulting layer 12 is smaller than heights t1 and t2.

In one embodiment, additional devices can be bonded to the target substrate after transfer of the functional devices 10 to the target substrate, for example, by repeatedly applying the processing steps of FIGS. 11F, 11G, and 11E with different devices. In one embodiment, a combinations of target substrate 400 and transferred devices thereupon can constitute an emissive display panel containing light emitting diodes that emit three or more different colors. In one embodiment, the emissive display panel comprises a direct view display panel containing red, green, and blue wavelength light emitting diodes and sensors bonded to the target substrate.

According to another aspect of the present disclosure, direct-lit displays are disclosed. Direct-lit displays can provide high dynamic range and large color gamut. The direct-lit displays of the present disclosure can employ RGB LED clusters or blue LEDs in combination with phosphor to provide a backplane which illuminates a liquid crystal display (LCD) screen, which is a liquid crystal display module (LCM). Local dimming is enabled by illuminating one or multiple pixels on the LCM with an individually-addressable LED.

In one embodiment, the LEDs can be transferred to a backplane (which may be an active backplane or a passive backplane) using a transfer process described below.

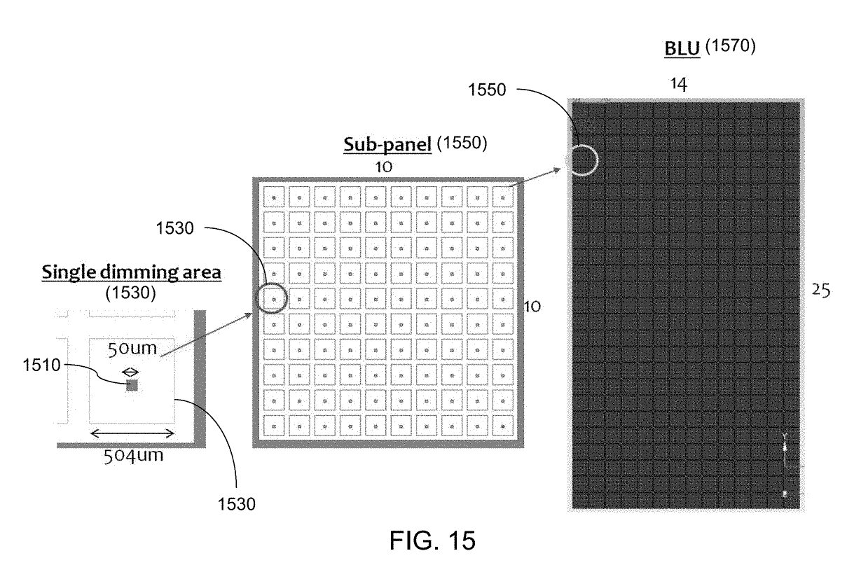

Referring to FIG. 15, a schematic is illustrated for construction of a dimming area. A typical pixel 1510 can have pixel lateral dimensions, i.e., dimensions by which each pixel laterally extend. In case a pixel 1510 has a square footprint, the two pixel lateral dimensions (e.g., a length and a width) can be the same. In an illustrative example, a square-footprint pixel can have an area of 31.5 micron×31.5 micron. A 16×16 square array of pixels 1510 can define a dimming area 1530 of about 504 microns×504 microns. A 10×10 array of dimming areas 1530 can define a sub-panel 1550. A backlight illumination unit (BLU) 1570 can be formed by an array of sub-panels 1550. FIG. 15 illustrates a BLU 1570 including a 14×25 array of sub-panels 1550.

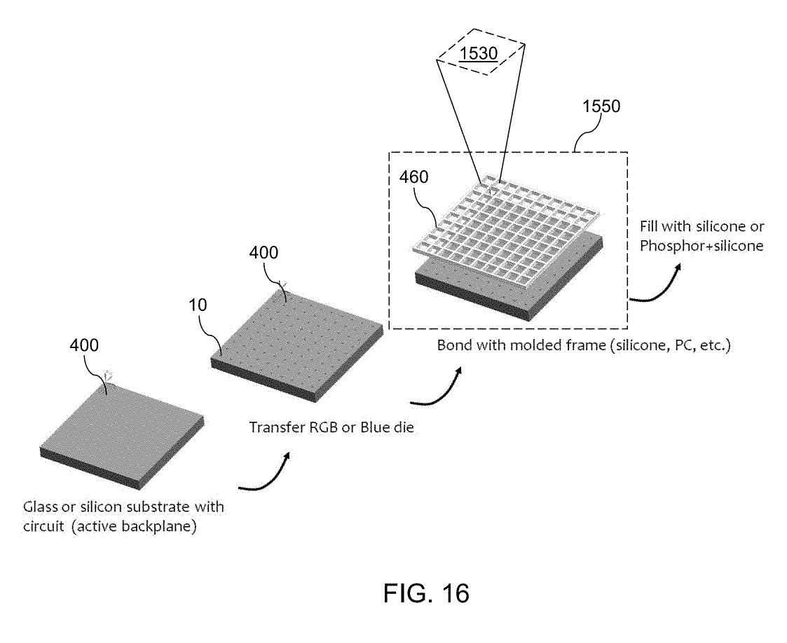

Referring to FIG. 16, an active backplane 400 (i.e., a backplane substrate) is provided, which comprise a substrate with circuits (which may be metal lines patterned on, or within, the substrate) for supporting operation of the light emitting diodes 10 to be attached thereupon, or attached as provided. The substrate can be a glass substrate or a silicon substrate.

In one embodiment, RGB light emitting diodes 10 (or alternatively, blue light emitting diodes) can be transferred employing any of the methods described above to the active backplane 400.

The active backplane 400 with the RGB diodes 10 thereupon is bonded with a molded frame 460, which can be made of a restraining material such as silicone or polycarbonate. The molded frame 460 can include a lattice structure including gaps therein. In one embodiment, each gap may correspond to a single dimming area 1530. The gaps inside the molded frame 460 can be subsequently filled with silicone or a combination of phosphor (in case the blue diodes are employed and suitable phosphors are needed to provide a gamut of color spectrum) and silicone to provide a sub-panel 1550. The sub-panels 1550 can be assembled to provide a backlight illumination unit 1570.

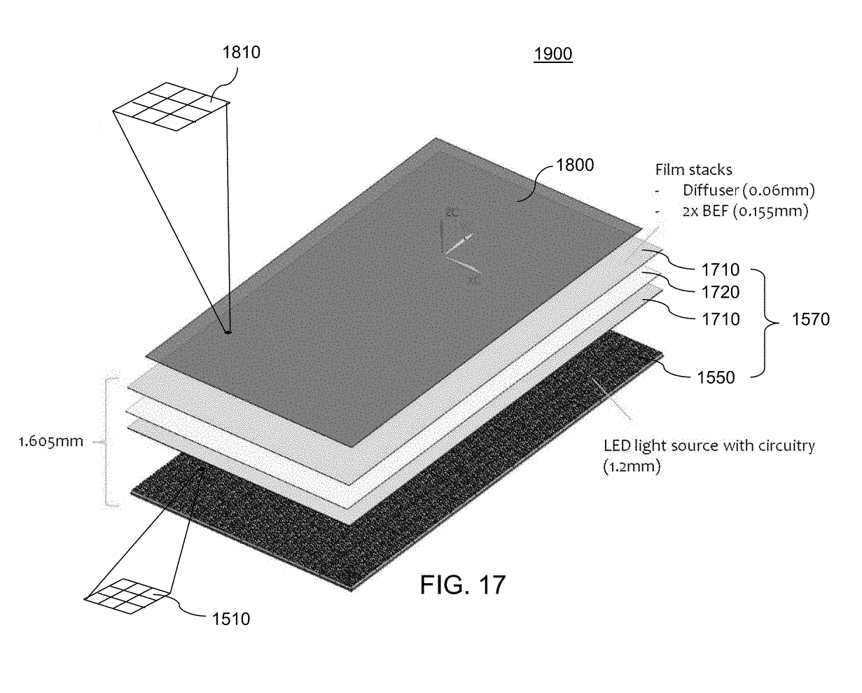

Referring to FIG. 17, a z-height stack-up scheme in a backlight illumination unit 1570 is illustrated. LED dies 10, which are light sources, are attached to a substrate 400 that includes a support circuitry. The LEDs 10 can be provided as sub-panels 1550 described above. One or more brightness enhancement films (BEFs) 1710 can be provided over the array of the sub-panels 1550. A diffuser film 1720 can be provided over the one or more BEFs. In an illustrative example, two BEFs 1710, each having a thickness of about 0.155 mm can be employed in conjunction with a 0.06 mm thick diffuser film 1720. The total thickness of the backlight illumination unit 1570 can be about 1.605 mm in this illustrative example.

The backplane 400 can be made using micro LEDs 10 which can be one or more of the following types. In one embodiment, the LEDs 10 may be planar micro LEDs (i.e., bulk LEDs made of thin films). The LEDs 10 may comprise a combination of red, green and blue emitting LEDs in one zone to emit white light from one dimmable zone 1530, or blue light or UV radiation emitting LEDs covered with a respective yellow or white light emitting phosphor, dye or quantum dots to emit white light from one dimmable zone 1530. In another embodiment, the LEDs 10 may be nanowire LEDs. The nanowire LEDs may comprise a combination of red, green and blue emitting nanowire LEDs in one zone to emit white light from one dimmable zone 1530, or blue light or UV radiation emitting nanowire LEDs covered with a respective yellow or white light emitting phosphor, dye or quantum dots to emit white light from one dimmable zone 1530. The red, green and blue emitting planar or nanowire LEDs may be grown on separate substrates and then transferred to the backplane, or they may be grown monolithically on the same substrate (e.g., all 3 RGB colors on a chip, as described in U.S. Pat. No. 9,054,233, issued Jun. 9, 2015, and incorporated herein by reference in its entirety) and then attached together to the backplane.

The LEDs 10 can be mounted on a passive or active backplane 400 which can be made of silicon, glass or organic or plastic flexible material. The electronics and/or electrodes on the backplane 400 address arrays of LEDs 10 which can be dimmed or brightened as dimmable zones 1530. A liquid crystal display screen 1800 can be disposed over the backlight illumination unit 1570. The LCD screen 1800 comprises an array of liquid crystal pixels 1810 (e.g., liquid crystal material between two transparent electrodes on a transparent substrate, optionally with an active matrix element, such as a thin film transistor, in each pixel).

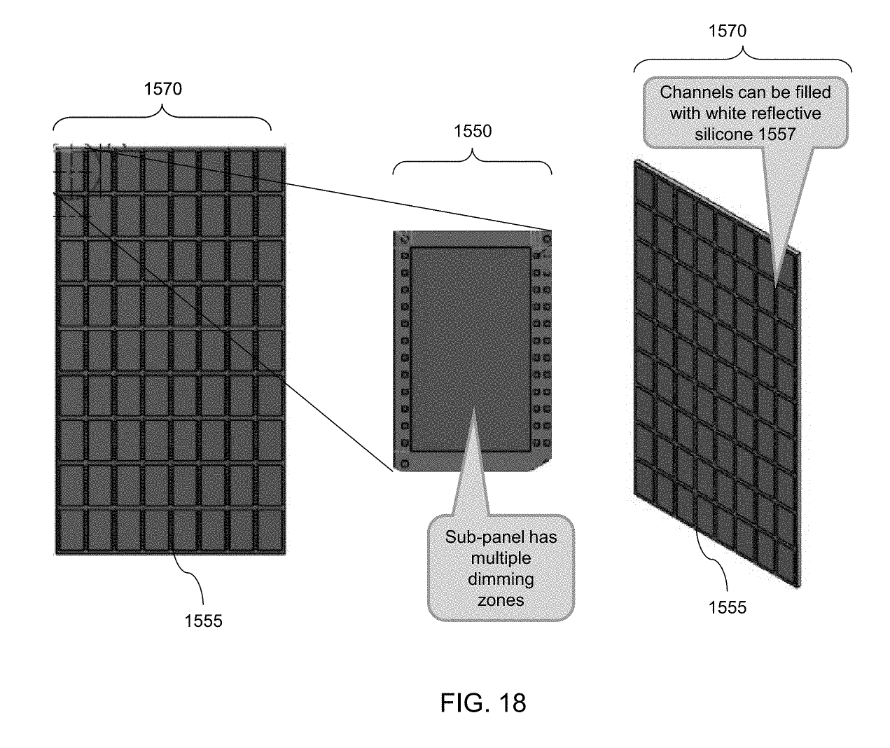

FIG. 18 illustrates a display unit (e.g., LCM) 1900 according to embodiment where passive or active sub-panels 1550 are built into a phone backplane. Each subpanel 1550 contains micro LEDs which are attached via a transfer process based on solder and laser soldering, as described above. Each sub-panel 1550 can be split into multiple dimming (i.e., dimming and brightening) zones 1530 containing individually controllable white light emitting LEDs described above, in order to achieve hundreds to thousands of dimmable (i.e., dimmable and brightenable) zones in the phone. The subpanels 1550 are closely spaced, but if there is a space (i.e., a channel 1555) between them, it may be filled with reflective material 1557 (silicone filled with a white reflective material such as TiO₂). The tiles are also made reflective by using reflective metal layers like Al, coated with dielectric layers.

The backlight illumination unit 1570 is then provided into a liquid crystal display screen 1800 (illustrated in FIG. 17) such that the light from the backlight illumination unit 1570 directly illuminates the liquid crystal material in the pixels 1810 of the liquid crystal display screen 1800. The backlight illumination unit 1570 is a direct light backlight unit, i.e., the LEDs 10 are located over an entire illumination area of the backlight illumination unit and radiate white light directly onto the respective LCD pixels 1810, such that white back light to each pixel 1810 can be independently brightened or dimmed. The direct light backlight unit is different from side illumination backlight units that employ light emitting diodes provided at an edge of a light guide plate that contains light scattering or light reflection features which illuminate all of the LCD pixels 1810 such that white back light for each pixel 1810 cannot be independently brightened or dimmed. In other words, light sources (e.g., LEDs 10) are located within the illumination area of the backlight unit of the present embodiment.

Local dimming or brightening of one or more selected LCM zones is provided by brightening or dimming one or more individually-addressable LED in each dimmable zone 1530 to provide more or less white light (or no white light if the LED(s) in one dimmable zone 1530 is turned off) to one or multiple liquid crystal display pixels 1810 located opposite to the controlled LED.

According to an aspect of the present disclosure and referring collectively to FIGS. 15-18, a display unit (e.g., LCM 1900) comprising a backlight illumination unit 1570 is provided. The backlight illumination unit 1570 comprises: a backplane substrate 400; a plurality of white-light-emitting light emitting diodes (LEDs) 10 attached to the backplane substrate 400 and arranged in a plurality of individually dimmable zones 1530; and electrodes located on the backplane substrate 400 and individually connected to each of the plurality of white-light-emitting LEDs 10. The plurality of white-light-emitting LEDs 10 are configured to be individually controllable to provide brighter or dimmer white light from each selected individually dimmable zone 1530 among the plurality of individually dimmable zones 1530.

In one embodiment, the backplane substrate 400 comprises a plurality of sub-panels 1550 arranged in an array configuration, and each individually dimmable zone 1530 is located in a respective one of the plurality of sub-panels 1550. In one embodiment, sub-panels 1550 within the plurality of sub-panels 1550 are separated from one another by channels 1555 filled with a reflective material. In one embodiment, each of the sub-panels 1550 comprises multiple dimming zones 1530. In one embodiment, each sub-panel 1550 comprises a frame 460 that includes a restraining material and containing an array of rectangular openings therein, wherein each rectangular opening within the array of openings includes a respective individually dimmable zone 1530. Alternatively, the openings (i.e., gaps) in the frame 460 may have a shape other than rectangular. In one embodiment, the display unit 1900 further comprises at least one optical-property-enhancing element (1710, 1720) located over the array of sub-panels 1550, wherein the at least one optical-property-enhancing element (1710, 1720) is selected from a brightness enhancement film 1710 and a diffuser film 1720.

In one embodiment, each of the individually dimmable zones 1530 comprises an m×m array of pixels 1510, wherein m is an integer greater than 1. For example, m can be 2, 3, 4, 5,6 ,7, 8, 9, 10, 11, 12, 13, 14,1 5, 16, 17, 18, 19, 20, 21, 22, 23, 24, 25, or any integer greater than 25 and less than 101, although 101 or a greater integer can also be employed for m. In one embodiment, each pixel 1510 within the m×m array of pixels 1510 comprises a respective combination of a red emitting LED, a green emitting LED, and a blue emitting LED. In one embodiment, each pixel 1510 within the m x m array of pixels 1510 comprises source LEDs selected from blue-light-emitting LEDs and UV-radiation-emitting LEDs and a wavelength-conversion material covering the source LEDs and selected from a phosphor, a dye, and quantum dots and providing white light upon irradiation by the source LEDs.

As used herein, a red-light-emitting diode or a red emitting LED refers to a light emitting diode configured to emit light at a peak wavelength, and more than 50% of light energy, in a range from 620 nm to 750 nm. A green-light-emitting diode or a green emitting LED refers to a light emitting diode configured to emit light at a peak wavelength, and more than 50% of light energy, in a range from 495 nm to 570 nm. A UV-radiation-emitting LED refers to a light emitting diode configured to emit light at a peak wavelength, and more than 50% of light energy, in a range from 200 nm to 400 nm. A blue-light-emitting diode or a blue emitting LED refers to a light emitting diode configured to emit light at a peak wavelength, and more than 50% of light energy, in a range from 400 to 495 nm.

In one embodiment, the display unit 1900 can further comprise a liquid crystal display (LCD) screen 1800 disposed over the backlight illumination unit 1570. In one embodiment, the LCD screen 1800 comprises an array of liquid crystal pixels 1810.

According to another aspect of the present disclosure, a method of operating a display unit 1900 includes selectively brightening or dimming one or more of the individually dimmable zones 1530 of the backlight illumination unit 1570 to directly selectively illuminate one or more liquid crystal pixels 1810 within an array of liquid crystal pixels 1810 with brighter or dimmer white light. Thus, the back light for each of the pixels 1810 can be selectively made brighter or dimmer (i.e., different) than for other pixels 1810 on the same LCD screen 1800.

According to another aspect of the present disclosure, a method of making a light emitting device (which can be a display unit, such as the LCM 1900) is provided. Light emitting diodes 10 can be transferred to a substrate 400 including a support circuitry to form an assembly of light emitting diodes 10 employing any of the methods described above. A molded frame 460 can be bonded to the assembly of light emitting diodes 10. Gaps in the molded frame 460 and located over the array of light emitting diodes 10 can be filled with a transparent plastic material to form a sub-panel 1550.

Multiple instances of the sub-panel 1550 can be manufactured. In one embodiment, a backlight illumination unit 1570 can be formed by assembling multiple instances of the sub-panel 1550. The multiple instances of the sub-panel 1550 can be arranged as an K×L rectangular array, in which K and L are integers greater than 1. Gaps 1555 between the multiple instances of the sub-panel 1550 can be filled with a reflective material. In one embodiment, a liquid crystal display (LCD) screen 1800 can be disposed over the backlight illumination unit 1570 to provide a display unit 1900. In one embodiment, at least one optical-property-enhancing element selected from a brightness enhancement film 1710 and a diffuser film 1720 can be disposed between the backlight illumination unit 1570 and the LCD screen 1800.

In one embodiment, the assembly of light emitting diodes 10 can be arranged in multiple dimming zones 1530 within each sub-panel 1550. Each of the multiple dimming zones 1530 contains a respective subset of the light emitting diodes 10 that is individually controllable for dimming or brightening. In one embodiment, the sub-panel 1550 comprises an m×m array of dimming zones 1530, wherein m is an integer greater than 1. In one embodiment, the support circuitry within the substrate 400 is configured to provide a variable voltage to each of the multiple dimming zones 1530 based on an input provided to the support circuitry for selective dimming or selective brightening.

The backplane substrate 400 is reflective in nature. Thus, more than 97% of the light impinging on a top surface of the backplane substrate 400 (for example, as emitted by the light emitting diodes 10) is reflected back toward the front side to the liquid crystal display screen 1800. The gaps between the sup-panels 1550 can be filled with a reflective material such as reflective silicone. After filling the gaps between the sub-panels, the entire assembly of the array of sub-panels 1550 can be encapsulated in a transparent protective material such as transparent silicone which can optionally be filled with an optical diffuser material. The at least one optical-property-enhancing element (1710, 1720) can be disposed over the continuous portion of the transparent protective material that covers and encapsulates the entire assembly of the sub-panels 1550.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. Where an embodiment employing a particular structure and/or configuration is illustrated in the present disclosure, it is understood that the present invention may be practiced with any other compatible structures and/or configurations that are functionally equivalent provided that such substitutions are not explicitly forbidden or otherwise known to be impossible to one of ordinary skill in the art.

1. A display unit comprising a backlight illumination unit, wherein the backlight illumination unit comprises:
a backplane substrate;
a plurality of white-light-emitting light emitting diodes (LEDs) attached to the backplane substrate and arranged in a plurality of individually dimmable zones; and
electrodes located on the backplane substrate and individually connected to each of the plurality of white-light-emitting LEDs,
wherein the plurality of white-light-emitting LEDs are configured to be individually controllable to provide brighter or dimmer white light from each selected individually dimmable zone among the plurality of individually dimmable zones.

2. The display unit of claim 1, wherein:
the backplane substrate comprises a plurality of sub-panels arranged in an array configuration; and
each individually dimmable zone is located in a respective one of the plurality of sub-panels.

3. The display unit of claim 2, wherein the sub-panels within the plurality of sub-panels are separated from one another by channels filled with a reflective material and wherein the backplane substrate is reflective.

4. The display unit of claim 2, wherein each of the sub-panels comprises multiple dimming zones.

5. The display unit of claim 2, wherein each sub-panel comprises a frame that includes a restraining material and containing an array of openings therein, wherein each opening within the array of openings includes a respective individually dimmable zone.

6. The display unit of claim 2, further comprising at least one of a brightness enhancement film or a diffuser film.

7. The display unit of claim 1, wherein each of the individually dimmable zones comprises an m x m array of pixels, wherein m is an integer greater than 1.

8. The display unit of claim 7, wherein each pixel within the m x m array of pixels comprises a respective combination of a red emitting LED, a green emitting LED, and a blue emitting LED.

9. The display unit of claim 7, wherein each pixel within the m×m array of pixels comprises source LEDs selected from blue-light-emitting LEDs and UV-radiation-emitting LEDs and a wavelength-conversion material covering the source LEDs and selected from a phosphor, a dye, and quantum dots and providing white light upon irradiation by the source LEDs.

10. The display unit of claim 1, further comprising a liquid crystal display (LCD) screen disposed over the backlight illumination unit.

11. The display unit of claim 10, wherein the LCD screen comprises an array of liquid crystal pixels and wherein the display unit comprises a direct lit liquid crystal display module.

12. A method of operating the display unit of claim 11, comprising selectively brightening or dimming one or more of the individually dimmable zones of the backlight illumination unit to directly illuminate one or more liquid crystal pixels within an array of liquid crystal pixels with brighter or dimmer white light.

13. A method of making a light emitting device, comprising:
transferring light emitting diodes to a substrate including a support circuitry to form an assembly of light emitting diodes;
bonding a molded frame to the assembly of light emitting diodes; and
filling gaps in the molded frame and over the array of light emitting diodes with a transparent plastic material to form a sub-panel.

14. The method of claim 13, further comprising forming a backlight illumination unit by assembling multiple instances of the sub-panel.

15. The method of claim 14, further comprising filling gaps between the multiple instances of the sub-panel with a reflective material.

16. The method of claim 15, further comprising disposing a liquid crystal display (LCD) screen over the backlight illumination unit to provide a direct lit liquid crystal display module.

17. The method of claim 16, further comprising disposing at least one of a brightness enhancement film and a diffuser film between the backlight illumination unit and the LCD screen.

18. The method of claim 13, wherein the assembly of light emitting diodes is arranged in multiple dimming zones within the sub-panel, wherein each of the multiple dimming zones contains a respective subset of the light emitting diodes that is individually controllable for dimming or brightening.

19. The method of claim 18, wherein the support circuitry is configured to provide a variable voltage to each of the multiple dimming zones based on an input provided to the support circuitry for selective dimming or selective brightening.

20. A method of operating a liquid crystal display module comprising a plurality of liquid crystal pixels and a backlight unit comprising plurality of white-light-emitting LEDs located in a plurality of individually dimmable zones, the method comprising selectively brightening or dimming one or more individually dimmable zones to directly illuminate one or more pixels with brighter or dimmer white light.

21. The method of claim 14, further comprising:
providing the light emitting diodes located on a source substrate;
forming a first bonding structure on each of the light emitting diodes while the light emitting diodes are located on the source substrate; and
forming second bonding structures on the substrate prior to transferring the light emitting diodes to the substrate;
wherein:
the light emitting diodes comprise micro light emitting diodes; and
transferring the light emitting diodes to the substrate comprises bonding each of the first bonding structures to a respective one of the second bonding structures to attach the light emitting diodes to the substrate, and detaching the light emitting diodes from the source substrate by ablating a region between the light emitting diodes and the source substrate by irradiating a laser beam that passes through the source substrate.
